(19) United States
(12) Patent Application Publication
(10) Pub. No.: US 2024/0249879 A1
(43) Pub. Date: Jul. 25, 2024

(54) ELECTRIC ELEMENT ASSEMBLY

(71) Applicant: JOINSET CO., LTD., Ansan-si (KR)

(72) Inventors: Sun-Ki Kim, Gunpo-si (KR); Kwang-Hwi Choi, Ansan-si (KR); Se-Deok Oh, Ansan-si (KR); Tae-Man Kang, Ansan-si (KR)

(21) Appl. No.: 18/418,026

(22) Filed: Jan. 19, 2024

(30) Foreign Application Priority Data
Jan. 20, 2023 (KR) 10-2023-0009070
Feb. 17, 2023 (KR) 10-2023-0021353
Mar. 15, 2023 (KR) 10-2023-0034207
Apr. 7, 2023 (KR) 10-2023-0045990

(51) Int. Cl. H01G 2/06; H01G 4/30; H01G 4/38

(52) U.S. Cl. CPC H01G 2/065; H01G 4/30; H01G 4/38

(57) ABSTRACT

Disclosed is an electric element assembly that may minimize the separation of a ceramic chip from a metal frame or the disconnection of internal electrodes from external electrodes due to external force. The electric element assembly includes an electric element and a metal frame, and each metal frame has an opening defined to correspond to an external electrode, and a flange provided to integrally extend from an edge of the opening in a direction to support the external electrode, and with the external electrode placed on the flange, the external electrode is bonded to the flange with an electrically conductive bonding agent.

### REFERENCE TO RELATED APPLICATIONS

This application claims the priority benefit of Korean Patent Application No. 10-2023-0009070 filed on Jan. 20, 2023 and Korean Patent Application No. 10-2023-0021353 filed on Feb. 17, 2023 and Korean Patent Application No. 10-2023-0034207 filed on Mar. 15, 2023 and Korean Patent Application No. 10-2023-0045990 filed on Apr. 7, 2023, the entire contents of which are incorporated herein by reference.

### FIELD OF THE INVENTION

The present invention relates to an electric element assembly, and more particularly, to a technology that minimizes separation of internal electrodes of an electrical device from external electrodes and minimizes destruction of the internal electrodes due to internal or external factors such as deformation, an impact, or heat of a circuit board.

### BACKGROUND OF THE INVENTION

Among electric element assemblies, ceramic chip assemblies such as multilayer ceramic capacitors (MLCC), chip resistors, or chip inductors have a structure in which single or multiple ceramic chips have various heat dissipation and electrical and mechanical performance, which are manufactured by arranging the single or multiple ceramic chips vertically or horizontally and interposing external electrodes disposed at opposite ends with solder and soldered to a metal frame.

FIG. 1 shows a ceramic chip assembly of U.S. Pat. No. 8,988,857 (hereinafter, referred to as the 857 patent).

With three ceramic chips 10 stacked vertically between metal frames 110 arranged opposite each other, external electrodes 12 at opposite ends of each ceramic chip 10 are respectively soldered to inner surfaces of the metal frames 110 through solder 20.

As is well known, the ceramic chip 10 is constituted by a ceramic body 11 and a pair of external electrodes 12 disposed on opposite ends of the ceramic body 11, and a plurality of internal electrodes 13 are stacked and embedded inside the ceramic body 11, one end of which is electrically connected to the external electrode 12.

The metal frame 110 is provided as a single body, and the external electrode 12 of the ceramic chip 10 is soldered to a vertical portion 111, and an end of the vertical portion 111 is inserted into a via hole of the circuit board 30 and soldered.

However, in the ceramic chip assembly having this structure according to the related art, opposite ends of the external electrodes are fixed only with solder to the inner surfaces of the metal frames. Thus, if the circuit board is bent or deformed by external force after soldering and mounting the metal frame on the circuit board, external force is transmitted directly to the external electrode through the metal frame and solder, causing cracks in the solder and causing the external electrode so as to be separated from the metal frame.

In addition, a connection portion at which the internal electrode is connected to the external electrode may be damaged due to the external force transmitted to the external electrode, or the internal electrode itself may be destroyed by the external force.

FIG. 2 shows a state in which a ceramic chip is deformed due to deformation of a circuit board according to the related art.

When external force is applied upward to the circuit board 30, the ceramic chip 10 is bent upward, and the metal frames 110 at opposite sides receive force that is spread outward.

As a result, a crack 21 may occur from the top of the solder 20 due to the external force, and if no crack 21 occurs, the external force is transmitted to the ceramic body 11 through the external electrode 12. During this process, the point 14 at which the internal electrode 13 and the external electrode 12 are connected may be broken.

Of course, the internal electrode 13 itself may be destroyed by the external force transmitted to the ceramic body 11.

A structure to prevent the external electrode from being separated from the metal frame has been proposed in Japanese Patent Laid-Open No. 2004-172562 (hereinafter referred to as the 562 patent). Disclosed is a composite electronic component characterized in that a central portion of a cross section of the terminal electrode of the ceramic electronic component protrudes outward to form a bulge that bulges in a transverse direction, the bulge is directed into one or more through-holes or notches installed in the center of the strip-shaped metal frame, and the bulge is soldered to the strip-shaped metal frame.

According to this structure, the soldering area is increased by the bulge to improve adhesion between the terminal electrode and the metal frame, thereby preventing the terminal electrode from being separated from the metal frame.

Additionally, the metal frame is cut in three places in the vertical direction so that the cut portion (tear piece) in the center supports a bottom surface of the composite.

However, since the tear piece is not soldered to the composite, the composite actually has a structure in which an end surface of the external electrode and the metal frame are coupled by interposing the solder, and as a result, the problem presented in the 857 patent remains.

A structure that interposes a minimum amount of solder between the external electrode and the metal frame has also been proposed, for example, Japanese Patent Publication 2019-179867 (hereinafter referred to as the 867 patent).

In the 867 patent, disclosed is a multilayer electronic component in which a pair of terminal electrodes of a condenser chip is connected to a pair of metal terminals, and the metal terminal is provided with a lower arm portion on the bottom surface of the opening of the terminal body portion to support the condenser chip.

However, even in this patent, the lower arm portion and terminal electrode are not soldered with solder, and there is a structure in which the terminal electrode is elastically pressed together with an upper arm, and the terminal electrode and the metal terminal are bonded by solder only on some areas. Thus, the condenser chip may be separated by external force.

Additionally, all of the above patents have the disadvantage of being difficult to apply when external electrodes, such as chip resistors or chip inductors, are disposed only on the bottom of a ceramic chip.

In other words, since the metal frame and ceramic chip are held together only by solder, if the ceramic chip is a power ceramic chip resistor or an MLCC with a high-Q value applied to RF power and generates a lot of heat during operation, the solder placed between the inner surface of the metal frame and the external electrode may melt or soften due to heat. At this time, depending on the deformation of the circuit board, the ceramic chip may be easily separated from the metal frame.

In the ceramic chip assembly according to the related art, it is difficult to provide diverse and uniform spacing between ceramic chips. For example, it is difficult to provide a wide gap between ceramic chips, making it difficult to maximize heat dissipation between ceramic chips, and it is difficult to provide a reliable and uniform gap between ceramic chips, making it difficult to provide a ceramic chip assembly with reliable performance.

In particular, in the above patent, since a composite made by stacking and bonding a plurality of single ceramic electronic components is used as the ceramic electronic component, there is a problem in heat dissipation because a sufficient gap between each ceramic electronic component is not secured. In other words, in a structure where the external electrodes of each ceramic electronic component are bonded to form a composite, the gap between the ceramic electronic components is provided by a height difference between the external electrode and the ceramic body, and thus sufficient spacing cannot be secured. The spacing between ceramic electronic components is not uniform due to the thickness of the solder interposed between external electrodes.

### SUMMARY OF THE INVENTION

Accordingly, an object of the present invention is to provide an electric element assembly in which an electric element and a metal frame are coupled together by solder and mechanical support or coupling is provided.

Another object of the present invention is to provide an electric element assembly that minimizes the separation or deformation of electric elements from a metal frame due to external force or heat.

Another object of the present invention is to provide an electric element assembly that minimizes external electrode deformation, electrical disconnection of the internal electrode from the external electrode, or damage to the internal electrode due to external force or heat.

Another object of the present invention is to provide an electric element assembly that facilitates maximization or partial uniformity of soldered areas between a metal frame and external electrodes.

Another object of the present invention is to provide an electric element assembly having a structure that easily accommodates electric elements having external electrodes of various types and sizes.

Another object of the present invention is to provide an electric element assembly that is easy to manufacture so that gaps between electric elements are diverse and uniform and the shape of solder has reliable quality.

Another object of the present invention is to provide a metal frame suitably applied to the above electric element assembly.

According to an aspect of the present invention, there is provided an electric element assembly mounted on a circuit board, the electric element assembly comprising: an electrical element constituted by a ceramic body and a pair of external electrodes disposed at opposite sides of the ceramic body to face each other; and a pair of metal frames coupled to each of the external electrodes, wherein each metal frame has one or more openings defined to face the external electrodes, and one or more flanges integrally extending inward from a lower edge of the openings, and in a state in which the external electrode is seated on the flange, the external electrode is bonded to the flange by an electrically conductive bonding agent so that the flange mechanically supports the external electrode.

The electrically conductive bonding agent may be any one of solder, metal powder/epoxy, or metal powder/glass.

The external electrode may be not inserted into the opening, and a length of the flange may be longer than that of the external electrode.

An end surface portion of the external electrode may be bonded to a metal frame portion disposed on an inner surface of the edge of the opening by the electrically conductive bonding agent.

Each of the opening and a metal frame portion adjacent to the edge of the opening may be individually covered with the electrically conductive bonding agent.

An end surface of the external electrode may be in contact with an inner surface of the metal frame, wherein a gap may be defined between the end surface and the inner surface.

A liquid electrically conductive bonding agent corresponding to the electrically conductive bonding agent may be bonded by flowing into a gap between an outer surface of the external electrode and a top surface of the flange and a gap between the end surface of the external electrode and the inner surface of the metal frame.

A pair of flanges may be provided by integrally extending inward from opposing edges of an opening, and a protrusion may be disposed on a surface of at least one of the pair of flanges facing the external electrode.

According to another aspect of the present invention, there is provided an electric element assembly mounted on a circuit board, the electric element assembly comprising: an electrical element constituted by a ceramic body and a pair of external electrodes disposed at opposite sides of the ceramic body to face each other; and a pair of metal frames coupled to each of the external electrodes, wherein each metal frame is constituted by a single body and a sidewall provided by being bent inward at each of opposite sides, a plurality of openings are defined in the sidewall in a vertical direction, cut portions of each opening are bent inward to face each other so as to provide a flange, and the external electrode is inserted between the flanges and physically coupled, and the external electrode is bonded to the flange by an electrically conductive bonding agent.

A support wall may be disposed on a sidewall between the adjacent openings in the vertical direction, so that the sum of a height of the support wall and a height of the opening may be equal to a thickness of the external electrode.

According to another aspect of the present invention, there is provided a metal frame constituted by a vertical portion and a horizontal portion provided by bending a lower end of the vertical portion, and coupled to an external electrode of an electric element at the vertical portion, the metal frame comprising: a flange configured to support the external electrode at the bottom; and an opening defined in a lower portion of the flange, wherein the flange is provided to integrally extend from an upper edge of the opening in a direction to support the external electrode, and the external electrode is seated on the flange and bonded to the flange by an electrically conductive bonding agent.

The opening may be defined to communicate with vertical and horizontal portions of the metal frame.

The other opening may be defined at the top of the flange through which an end surface of the external electrode of the electric element may be exposed.

The other opening may be closed at all edges or opened at an upper edge.

### BRIEF DESCRIPTION OF THE DRAWINGS

The above objects and other advantages of the present invention will become more apparent by describing in detail exemplary embodiments thereof with reference to the attached drawings in which:

FIG. 1 shows an example of a ceramic chip assembly according to a related art;

FIG. 2 shows a state in which a ceramic chip is deformed due to deformation of a circuit board according to the related art;

FIGS. 3A and 3B each show a ceramic chip assembly according to a first embodiment of the present invention;

FIG. 4 shows a state in which a ceramic chip is deformed due to deformation of the circuit board in the present invention;

FIGS. 5A and 5B each show a ceramic chip assembly according to a second embodiment of the present invention;

FIGS. 6A and 6B each show a ceramic chip assembly according to a third embodiment of the present invention;

FIG. 7 shows a ceramic chip assembly according to a fourth embodiment of the present invention; and

FIGS. 8A to 8C each show a ceramic chip assembly and a metal frame applied thereto according to a fifth embodiment of the present invention.

### DETAILED DESCRIPTION OF THE INVENTION

It should be noted that the technical terms used in the present invention are only used to describe specific embodiments and are not intended to limit the present invention. In addition, unless specifically defined differently in the present invention, the technical terms used in the present invention should be interpreted as meanings commonly understood by those of ordinary skill in the technical field to which the present invention pertains, and should not be interpreted in an overly comprehensive sense or in an excessively reduced sense.

Hereinafter, a ceramic chip assembly according to the present invention will be described in detail with reference to the attached drawings. Here, the attached drawings are intended to aid understanding of the present invention, and for convenience of explanation, the dimensions of some components may be ignored and may be shown somewhat exaggeratedly.

For convenience of explanation, a ceramic chip is used as an example of an electrical element in each embodiment, but electrical components with other structures and functions may also be included.

### First Embodiment

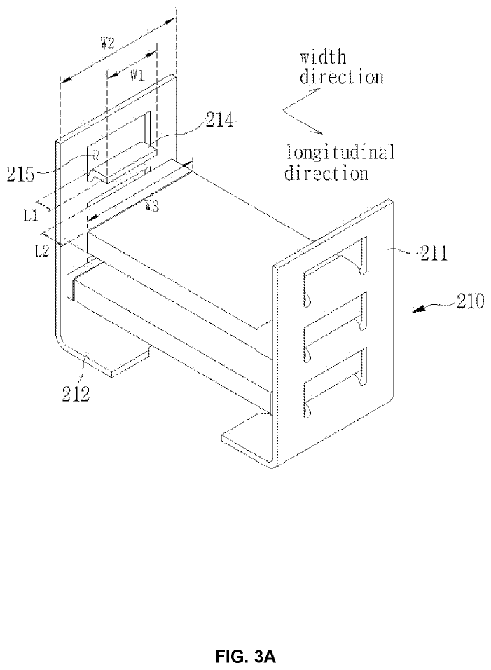

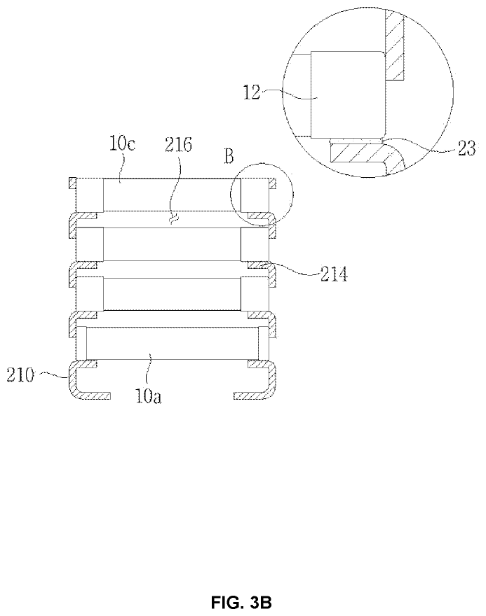

FIGS. 3A and 3B each show a ceramic chip assembly according to the first embodiment of the present invention.

The ceramic chip assembly 100 includes one or more ceramic chips 10 with external electrodes 12 disposed on opposite ends, and a pair of metal frames 210 coupled to each other to face the external electrodes 12. Each of the metal frames 210 has one or more openings 215 and a flange 214 extending horizontally from one of edges of the openings 215 in a direction of supporting the external electrode 12.

The ceramic chip assembly 100 is reel taped to enable vacuum pickup and reflow soldering using solder cream, but is not limited thereto depending on the overall dimensions or weight of the ceramic chip assembly 100 and the mounting method to the object.

The horizontal portion 212 of the metal frame 210 of the ceramic chip assembly 100 is soldered to the circuit pattern of the circuit board 30 by soldering, and the size and position of the circuit pattern are designed in advance to correspond to the size and position of the external electrode 12.

Hereinafter, each component will be described in detail.

### <Ceramic Chip 10>

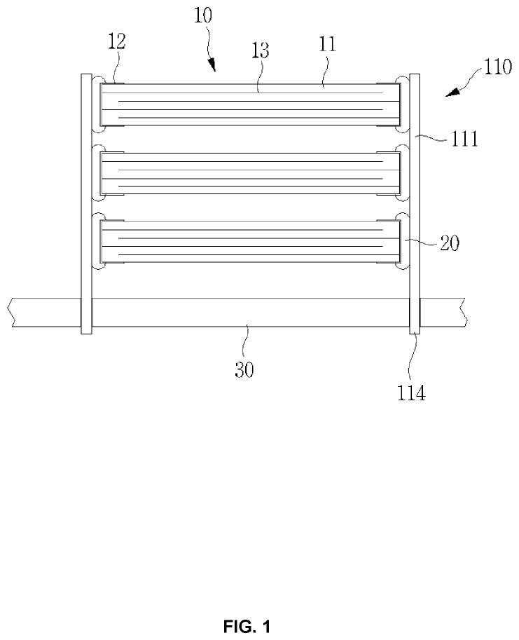

As shown in FIG. 1, the ceramic chip 10 is composed of a ceramic body 11 and a pair of external electrodes 12 disposed on opposite ends of the ceramic body 11. For example, inside the ceramic body 11, an internal electrode 13 is disposed to be electrically connected to the external electrodes 12 at opposite ends.

In this embodiment, the ceramic chip 10 in which the external electrodes 12 are disposed on opposite ends of the ceramic body 11 is used as an example. However, without limited thereto, the external electrode 12 may be a chip resistor or a chip inductor disposed on opposite ends of the bottom surface of the ceramic chip 10.

There is more than one ceramic chip 10 constituting the ceramic chip assembly 100, and when there are multiple ceramic chips 10, it is preferable that the ceramic chips 10 have the same dimensions, but are not limited thereto.

In this embodiment, the ceramic chip 10 is constituted by four capacitors with the same performance stacked at regular intervals and connected in parallel, and the current is distributed by ¼ compared to the case with one capacitor.

The ceramic chip 10 may be a ceramic capacitor, a chip resistor, a chip inductor, or a combination thereof, but is not limited thereto.

The dimensions and shape of the ceramic chip 10 are not particularly limited, but for example, the ceramic chip has a hexahedral shape with width×length×height ranging from 0.8 mm×1.6 mm×0.3 mm to 10 mm×10 mm×3 mm. Preferably, the dimensions of the pair of external electrodes 12 disposed opposing opposite ends of the ceramic body are the same, and the length of the external electrode 12 may be 0.2 mm to 3 mm depending on the size of the ceramic chip 10, but are not limited thereto.

### <Metal Frame 210>

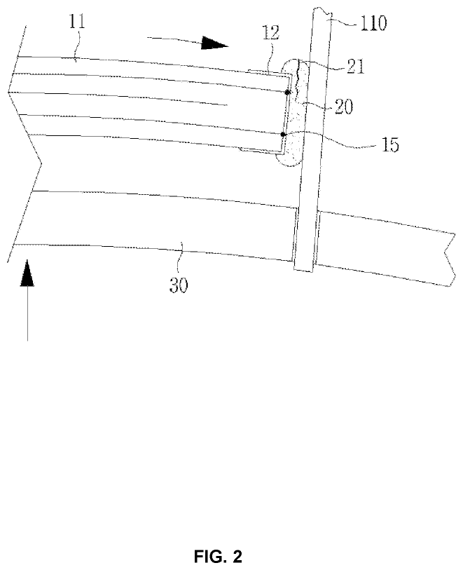

A pair of metal frames 210 are constituted by a horizontal portion 212 mounted on a circuit board, etc., and a vertical portion 211 that secures the ceramic chip 10. As shown in FIG. 2A, at least one opening 215, for example, of a square shape, is defined in the vertical portion 211, and a flange 214 extending horizontally from the lower edge of each opening 215 in a direction supporting the external electrode 12 is provided to be integrated with the metal frame 210.

For each metal frame 210, openings 215 form opposing pairs, and thus flanges 214 form opposing pairs.

The flange 214 is provided by, for example, bending a cut portion to form the opening 215, and the flange 214 supports the bottom surface of the external electrode 12 of the ceramic chip 10 in a horizontal and flat manner.

The horizontal portion 212 is provided by bending the lower end of the metal frame 210 toward the inside or outside of the metal frame, and the horizontal portion 212 is bent at a certain distance from the lowest ceramic chip 10 to prevent the body of the ceramic chip 10 from contacting the circuit board on which the horizontal portion is mounted.

The horizontal portion 212 is mounted on the circuit board 30 via solder 24, and the shape of the horizontal portion 212 corresponds to a shape that may be soldered to the circuit pattern of the circuit board 30.

The material of the metal frame 210 may be copper, copper alloy, or stainless steel, and the outermost layer of these materials may be a tin layer provided by plating to prevent corrosion and facilitate soldering, but is not limited thereto.

The thickness of the metal frame 210 may preferably be 0.05 mm to 0.20 mm in consideration of the size and number of ceramic chips 10, but is not limited thereto.

In this embodiment, the portion in which the opening 215 is defined is cut into a [symbol] shape to form one flange 214, and the portion where the opening 215 is formed may be cut into a [symbol] shape to form a pair of flanges facing each other in one opening 215.

The opening 215 may be defined by press punching and bending the metal frame 210, or etching and press bending.

In addition to increasing the soldering area, the flange 214 mechanically and stably supports the external electrode 12 and the ceramic chip 10 over a large area.

Optionally, for the purpose of increasing soldering area, the flange 214 may be configured to extend horizontally from an edge other than the bottom edge of the opening 215.

The width and length of the flange 214 provided by the opening 215 may be determined in various ways depending on the width and length of the external electrode 12 seated there.

Looking at FIG. 3A, the width W2 of the metal frame 210 is the same or similar to the width W3 of the external electrode 12, and preferably, the width W1 of the flange 214 may be smaller than the width W3 of the external electrode 12 of the ceramic chip 10.

To explain this specifically, the circuit pattern preformed on the circuit board 30 is designed to correspond to the size of a typical ceramic chip, so that the size of the circuit pattern is approximately similar to the size of the external electrode 12 of the ceramic chip 10. Therefore, by making the width W2 of the metal frame 210 the same as or similar to the width W3 of the external electrode 12, the metal frame 210 may be easily mounted on a circuit pattern in which only the ceramic chip 10 according to the related art is mounted. In addition, since the paired metal frames 210 are symmetrical, it is easy to produce ceramic chip assemblies.

Additionally, if the width W2 of the metal frame 210 is equal to the width W3 of the external electrode 12, the width W1 of the flange 214 provided by the opening 215 is inevitably smaller than the width W3 of the external electrode 12.

Additionally, in this embodiment, the length L1 of the flange 214 is shorter than the length L2 of the external electrode 12, but is not limited thereto, and the length of the external electrode 12 may be made longer than L2 so that the flange 214 stably supports the external electrode 12.

In this case, the vertical length of the opening 215 increases by the length L1 of the flange 214, and as a result, the gap between the ceramic chips 10 increases, thereby increasing the overall height of the ceramic chip assembly.

Referring to FIG. 3B, as shown in the enlarged circle, when the area of the opening 215 is smaller than the area of the end surface of the external electrode 12, the end surface of the external electrode 12 is in contact with the inner surface around the opening 215 of the metal frame 210, the bottom surface of the external electrode 12 is bonded to the flange 214 via solder 23.

Referring to FIG. 3B, the bottom surface of the external electrode 12 is bonded to the flange 214 via solder 23. At the same time, the end surface portion of the external electrode 12 may be bonded to the inner surface around the opening 215 of the metal frame 210 via another solder.

According to this structure, the end surface of the external electrode 12 and the inner surface around the opening 215 of the metal frame 210 are additionally bonded by solder, thereby increasing the overall soldering strength.

In addition, the end surface and the bottom surface of the external electrode 12 are respectively bonded to the metal frame part and the flange 214. Thus, by dispersing or absorbing external vibration or shock, preventing concentration of stress, separation or deformation of the external electrode 12 from the metal frame 210 may be minimized.

In contrast, the external electrode 12 of the ceramic chip 10 may be completely inserted into the opening 215 so that the end surface of the external electrode 12 matches the surface of the vertical portion 211 of the metal frame 210.

In this case, the bottom surface of the external electrode 12 is bonded to the flange 214 through the solder 23. At the same time, the top and side portions of the external electrode 12 may be bonded to the fleshy portions of the top and side edges of the opening 215 of the metal frame 210 via another solder.

On the other hand, when the length of the external electrode 12 is very short, such as the ceramic chip 10a in FIG. 3b, the length of the flange 214 is much longer than the length of the external electrode 12, so that the external electrode 12 is completely placed on the flange 214. Solder 23 is widely spread and interposed between the external electrode 12 and the flange 214, thereby increasing soldering strength.

In this embodiment, the solder 23 is used to join the external electrode 12 and the flange 214 as an example, but above 300° C., a metal electrically conductive bonding agent of metal powder and epoxy or metal powder and glass may be applied.

In addition, preferably, as shown in FIG. 3B, the height of the top of the metal frame 210 may be the same as or similar to the height of the top surface of the ceramic chip 10c located at the top.

This structure has the following advantages.

The external electrode of the ceramic chip is seated on a flange with a large area and soldered, so that the connection between the external electrode and the metal frame is more stable by combining solder joint and mechanical connection in parallel.

Additionally, even when external electrodes, such as chip resistors or chip inductors, are disposed only on the bottom surface of the ceramic chip, the ceramic chip may be stably mounted on the metal frame.

In addition, if the ceramic chip is a power ceramic chip resistance or MLCC with a high-Q value applied to RF power and generates a lot of heat during operation, even if the solder melts or softens due to heat, the ceramic chip is not easily separated from the metal frame because the ceramic chip is supported by mechanical bonding.

Meanwhile, the spacing between each ceramic chip may be secured sufficiently wide by using a flange, and all spacings may be made uniform. Thus, a heat dissipation effect may be achieved through air flow through the gap between ceramic chips, and it is easy for each ceramic chip to have uniform performance.

In addition, structurally, it is easy to minimize deformation of the external electrode due to external force, thereby minimizing the internal electrode being disconnected from the external electrode.

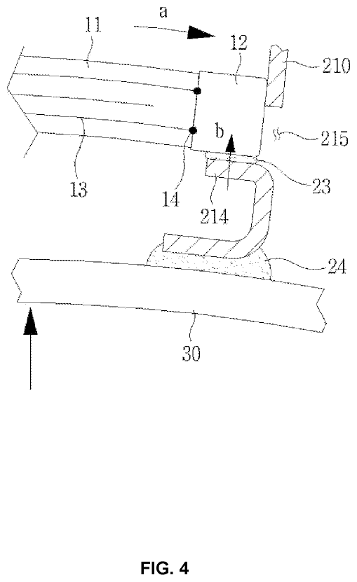

FIG. 4 shows a state in which a ceramic chip is deformed due to deformation of the circuit board in the present invention.

As indicated by the arrow, when external force is applied upward to the circuit board 30, the ceramic chip 10 bends upward, and the metal frames 210 on opposite sides receive a force that spreads outward as indicated by arrow a.

However, since the end surface of the external electrode 12 is not bonded to the metal frame 210 by solder, the external electrode 12 is not directly pulled in even if the metal frame 210 opens outward.

Moreover, since the flange 214, as indicated by arrow b, receives an upward force, the external electrode 12 moves along the metal frame 210 that spreads outward. As a result, no force is applied to the point 14 where the internal electrode 13 and the external electrode 12 are connected, thereby preventing the internal electrode 13 from breaking at that point 14.

In other words, by structurally preventing external force from being transmitted to the external electrode 12 itself, breakage of the internal electrode 13 may be minimized and the internal electrode 13 itself may be prevented from being damaged.

### Second Embodiment

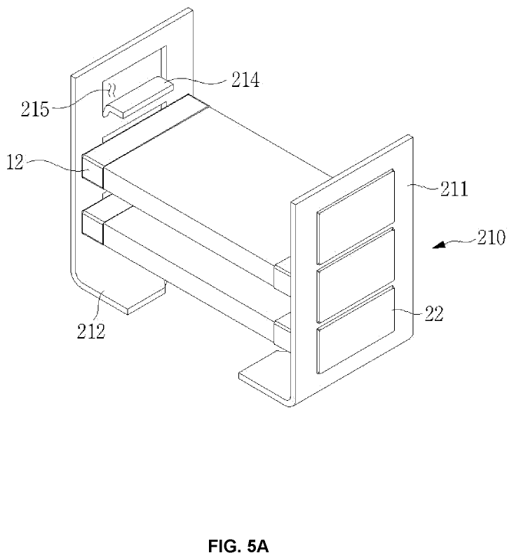

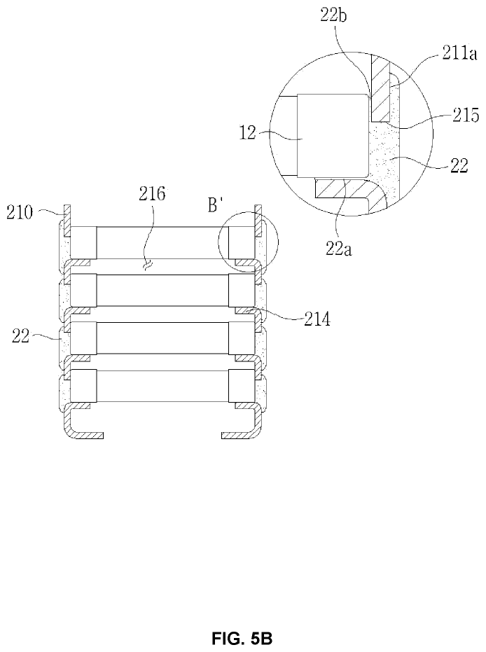

FIGS. 5A and 5B each show a ceramic chip assembly according to a second embodiment of the present invention.

In a state where the bottom surface of the external electrode 12 is placed on the flange 214 of the metal frame 210 and the end surface of the external electrode 12 is in contact with the inner surface around the opening 215 of the metal frame 210, solder 22 is applied to individually cover each metal frame portion including each opening 215.

Likewise, by individually applying the solder 22 to each opening 215, the amount of solder may be reduced and soldering work is easy compared to applying the entire outer surface of the metal frame 210.

Solder 22 may be provided by applying heat to solder cream or solder wire, and solder cream has the advantage of being in a liquid state, making it easier to form solder 22 in the opening 215 than solder wire.

For example, when solder cream is applied, liquid solder cream may be pushed into the minute gap or empty space defined between the external electrode 12 and the metal frame 210 to form solder, and solder cream is easy to perform reflow soldering.

Looking at the enlarged original in FIG. 5B, the liquid solder cream that forms the solder 22 flows into the gap between the bottom surface of the external electrode 12 and the top surface of the flange 214 to form the solder 22a to form the end surface of the external electrode 12 and the top surface of the flange 214, and flows into the gap between the inner surfaces around the opening 215 of the metal frame 210 to form the solder 22b.

In particular, the gap between the bottom surface of the external electrode 12 is small due to the weight of the ceramic chip 10 placed on the top surface of the flange 214, but the solder cream, which is melted by heat and has a lower viscosity, passes through the small gap, and solder 22a may be provided.

Through this soldering process, the solder 22 covers the outer surface portion 211a around the opening 215 of the metal frame 210, and solders 22a and 22b are disposed respectively in a gap between the bottom surface of the external electrode 12 and the top surface of the flange 214 and a gap between the end surface of the external electrode 12 and the inner surface around the opening 215 of the metal frame 210, and thus overall, the soldering area increases. Since external vibration or shock is dispersed and absorbed in the metal frame portion and the flange 214, concentration of stress may be prevented, thereby minimizing separation or deformation of the external electrode 12 from the metal frame 210.

In addition, if the circuit board 30 is bent or deformed after soldering and mounting the metal frame 210 on the circuit board 30, or if external vibration or impact is applied, in response thereto, the flange 214 operates elastically to absorb or disperse the applied force, thereby minimizing the separation or deformation of the external electrode 12 of the ceramic chip from the metal frame 210.

### Third Embodiment

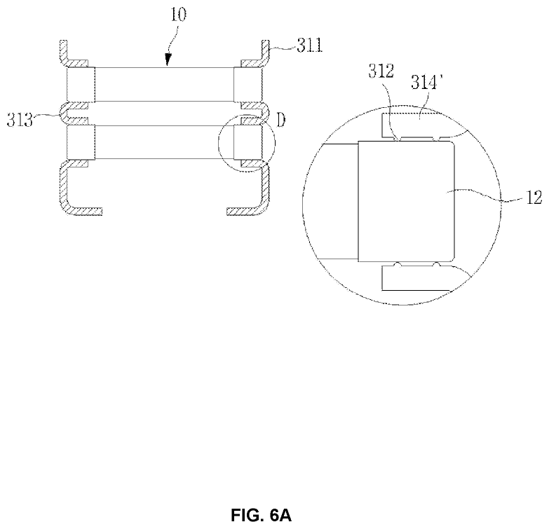

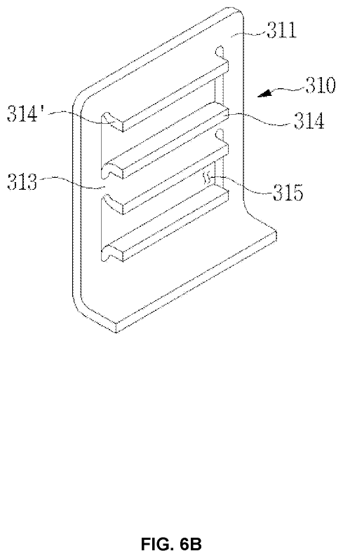

FIGS. 6A and 6B each show a ceramic chip assembly according to a third embodiment of the present invention.

Referring to FIG. 6B, one or more openings 315 of the same or different sizes are defined in the metal frame 310, and for each opening 315, flanges 314 and 314′ extend from the upper and lower edges, respectively, forming a pair.

In this embodiment, flanges 314 and 314′ are shown extending from the top and bottom edges of opening 315, but are not limited thereto, and may extend from left and right edges of opening 315. In this case, the flange does not support the external electrode 12 in the vertical direction, but may elastically support the same in the left and right directions due to the elasticity of the flange itself.

Preferably, each flange 314, 314′ may have the same length, and their sum may be equal to or smaller than the vertical length of the opening 315.

Referring to FIG. 6A, the external electrode 12 of the ceramic chip 10 is inserted between a pair of flanges 314 and 314′ corresponding to each opening 315 and is physically coupled. At this time, the flanges 314 and 314′ have elasticity in the vertical direction and are therefore elastically coupled to the external electrode 12.

According to this embodiment, the external electrode is sandwiched between a pair of flanges, physically coupled, and then bonded to the flange with an electrically conductive bonding agent, so that it is possible to have uniform quality and manufacturing is easy.

As shown in the enlarged circle, protrusions 312 may be disposed to protrude on the surfaces of the flanges 314 and 314′ facing the external electrodes 12. According to this structure, while the flanges 314 and 314′ are elastically coupled to the external electrode 12, the protrusion 312 may press the surface of the external electrode 12 to make the coupling stronger.

In addition, when the external electrode 12 is inserted between the flanges 314 and 314′ of the metal frame 310 and a ceramic chip assembly, to which a ceramic chip 10 is mounted, is immersed in, for example, a solder bath, molten solder penetrates between the flanges 314 and 314′ and the external electrode 12. At this time, a gap between the flanges 314 and 314′ and the external electrode 12 is clearly defined by the protrusion 312, thereby securing a sufficient amount of molten solder, and as a result, soldering strength increases.

### Fourth Embodiment

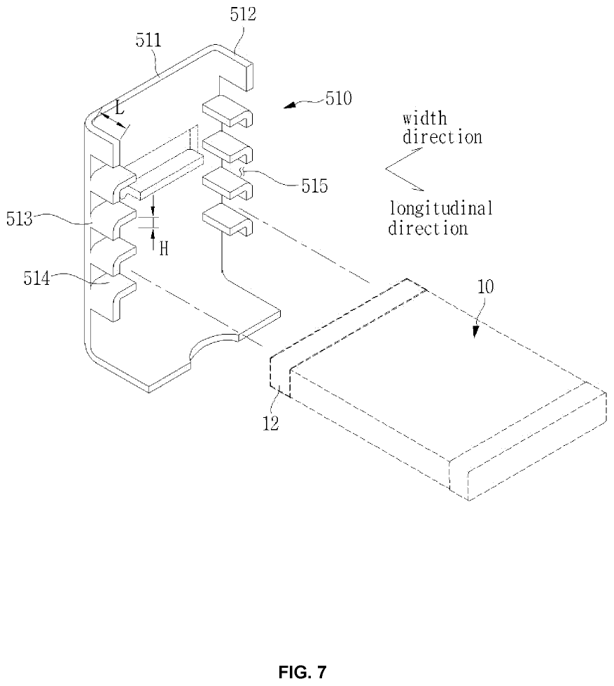

FIG. 7 shows a ceramic chip assembly according to a fourth embodiment of the present invention. For convenience, a situation in which the external electrodes 12 of the ceramic chip 10 are coupled to one metal frame 510 is shown.

The metal frame 510 is constituted by a single body 511 and sidewalls 512 that are bent on opposite sides of the body 511 in a direction to support the external electrodes 12, defining a ⊏ shape when viewed from above.

Here, the length L of the sidewall 512 has a length corresponding to the length of the external electrode 12 of the ceramic chip 10.

A plurality of openings 515 are defined in the sidewall 512 in the vertical direction, and the cut portions of each opening 515 are bent inwardly opposite each other to form a flange 514.

Accordingly, the flange 514 has a length and width corresponding to the horizontal and vertical lengths of the opening 515 when viewed from the outside of the sidewall 512.

In addition, a support wall 513 is disposed on the sidewall between the vertically adjacent openings 515, and the external electrode 12 of the ceramic chip 10 is inserted into the gap between the adjacent flanges 514 and is physically coupled thereto. Thus, the sum of the height H of the support wall 513 and the height of the opening 515 is equal to the thickness of the external electrode 12 of the ceramic chip 10.

According to this structure, since one side of the opening 515 is open, the flange 514 may be easily bent. Since the gap between adjacent ceramic chips 10 may be set only by the thickness of the flange 514, the gap may be minimized and the stacking density of ceramic chips in the vertical direction may be greatly increased.

Optionally, as shown by the dotted line in FIG. 7, the support strength may be increased by forming an opening in the main body 511 between the opposing flanges 514 and additionally forming a flange protruding inward.

### Fifth Embodiment

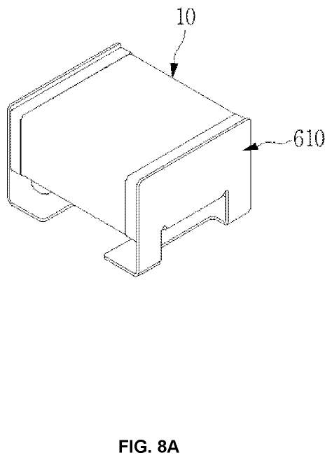

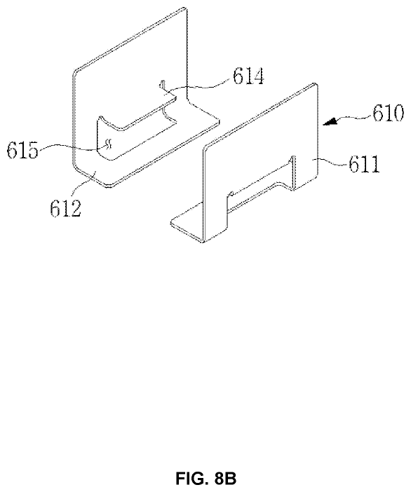

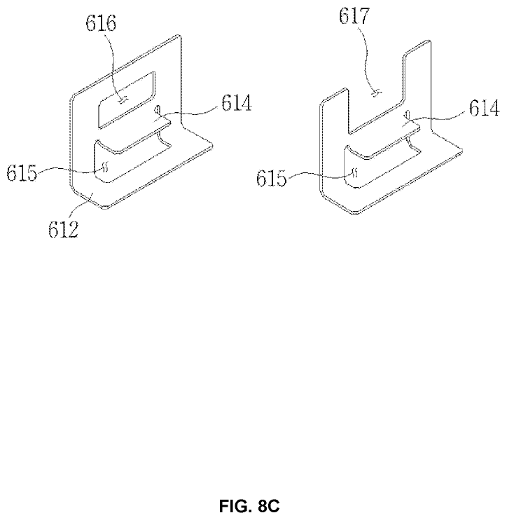

FIGS. 8A to 8C each show a ceramic chip assembly and a metal frame applied thereto according to the fifth embodiment of the present invention.

Referring to FIG. 8B, the metal frame 610 has an opening 615 defined in the lower portion of the flange 614.

An opening 615 at the bottom of the flange 614 is cut and bent upward to form the flange 614, and the flange 614 may be disposed longer by cutting a portion of the vertical portion 611 of the metal frame 610 and a portion of the horizontal portion 612 communicating therewith.

In the above embodiments, an opening with a certain height is required to form a flange of a certain length, and thus there is a limit to reducing the overall height of the ceramic chip assembly.

On the other hand, according to this embodiment, in a typical structure, an opening is defined in the gap between the bottom surface of the ceramic chip and the horizontal part of the metal frame, and a flange may be provided from the portion in which the opening is cut. The opening in the upper part of the flange may be selectively defined, or the height of the opening may be reduced to reduce the overall height of the ceramic chip assembly.

Referring to FIG. 8C, the soldering strength of the end surface of the external electrode 12 of the ceramic chip 10 may be increased by forming openings 616 and 617 in the upper part of the flange 614.

In this case, the height of the openings 616 and 617 may be adjusted so that the overall height of the ceramic chip assembly does not increase.

The same may be provided in a closed shape with the opening 616, or the upper edge may be opened upward with the opening 617, so that more solder may be attached to the external electrode of the ceramic chip 10 during soldering.

In the above embodiment, a ceramic chip with external electrodes disposed on opposite ends of a ceramic body is described as an example, but the present invention is not limited thereto.

For example, the same may be applied to an electrical device that has a functional body made of polymer resin instead of a ceramic body and an electrode made of a metal plate exposed to the outside from the polymer body. For example, an electrical element such as a chip coil inductor made of polymer or ferrite may be applied by seating it on the flange of the metal frame of the present invention.

In addition, the same may be applied when the external electrode is a chip resistor with a structure extending from opposite ends of the body to the bottom of the body or a chip inductor provided to protrude from the bottom of the body. In this case, the dimensions and shape of the opening or flange may be adjusted so that the external electrode of the chip resistor is seated on the lower edge of the opening or the top surface of the flange.

A ceramic chip assembly of the present invention may be provided by selecting the size of the external electrode, the size and number of openings, the size and number of flanges, the size and shape of the metal frame, and the circuit pattern of the circuit board, which are not described in the above embodiment, to suit the purpose of the present invention.

According to the present invention, it is possible to structurally minimize the deformation of the external electrode due to external force, thereby minimizing the internal electrode being disconnected from the external electrode.

In addition, the soldering strength increases due to an increase in the area where the external electrode is soldered, thereby minimizing separation of the electrical elements from the metal frame due to external force after mounting the metal frame on the circuit board.

In addition, even if external force is applied to the external electrode, the flange bonded to the external electrode by soldering absorbs part of the external force, thereby reducing the external force applied to the external electrode or the ceramic body. As a result, it is possible to prevent the external electrode from being deformed or the internal electrode to be disconnected from the external electrode, and damage to the internal electrode itself may be minimized.

In addition, the external electrode of the electric device is seated and soldered on a flange with a large area, increasing the soldering area and stably supporting the external electrode, making the connection between the external electrode and the metal frame more stable.

In addition, by applying a flange, it is easy to provide uniformity while securing sufficient spacing between electrical elements, and it is easy to manufacture with reliable quality.

In addition, since the external electrode is sandwiched between a pair of flanges and physically bonded and is then bonded to the flange using an electrically conductive bonding agent, it is possible to have uniform quality and manufacturing is easy.

Although the above description focuses on embodiments of the present invention, various changes and modifications may be made at the level of those skilled in the art. These changes and modifications may be said to belong to the present invention as long as they do not depart from the scope of the present invention. The scope of rights of the present invention should be determined by the claims set forth below.

What is claimed is:

1. An electric element assembly mounted on a circuit board, the electric element assembly comprising:
an electrical element constituted by a ceramic body and a pair of external electrodes disposed at opposite sides of the ceramic body to face each other; and
a pair of metal frames coupled to each of the external electrodes,
wherein each metal frame has one or more openings defined to face the external electrodes, and a flange integrally extending inward from a lower edge of each of the openings, and
in a state in which the external electrode is seated on the flange, the external electrode is bonded to the flange by an electrically conductive bonding agent so that the flange mechanically supports the external electrode.

2. The electric element assembly of claim 1, wherein the electrically conductive bonding agent is any one of solder, metal powder/epoxy, or metal powder/glass.

3. The electric element assembly of claim 1, wherein the external electrode is not inserted into the opening, and a length of the flange is longer than that of the external electrode.

4. The electric element assembly of claim 1, wherein an end surface portion of the external electrode is bonded to a metal frame portion disposed on an inner surface of the edge of the opening by the electrically conductive bonding agent.

5. The electric element assembly of claim 1, wherein each of the opening and a metal frame portion adjacent to the edge of the opening are individually covered with the electrically conductive bonding agent.

6. The electric element assembly of claim 1, wherein an end surface of the external electrode is in contact with an inner surface of the metal frame,
wherein a gap is defined between the end surface and the inner surface.

7. The electric element assembly of claim 6, wherein a liquid electrically conductive bonding agent corresponding to the electrically conductive bonding agent is bonded by flowing into a gap between an outer surface of the external electrode and a top surface of the flange and a gap between the end surface of the external electrode and the inner surface of the metal frame.

8. The electric element assembly of claim 1, wherein a pair of flanges are provided by integrally extending inward from opposing edges of the opening, and
a protrusion is disposed on a surface of at least one of the pair of flanges facing the external electrode.

9. An electric element assembly mounted on a circuit board, the electric element assembly comprising:
an electrical element constituted by a ceramic body and a pair of external electrodes disposed at opposite sides of the ceramic body to face each other; and
a pair of metal frames coupled to each of the external electrodes,
wherein each metal frame is constituted by a single body and a sidewall provided by being bent inward at each of opposite sides,
a plurality of openings are defined in the sidewall in a vertical direction, cut portions of each opening are bent inward to face each other so as to provide a flange, and
the external electrode is inserted between the flanges and physically coupled, and the external electrode is bonded to the flange by an electrically conductive bonding agent.

10. The electric element assembly of claim 9, wherein a support wall is disposed on a sidewall between the adjacent openings in the vertical direction, so that the sum of a height of the support wall and a height of the opening is equal to a thickness of the external electrode.

11. A metal frame constituted by a vertical portion and a horizontal portion provided by bending a lower end of the vertical portion, and coupled to an external electrode of an electric element at the vertical portion, the metal frame comprising:
a flange configured to support the external electrode at the bottom; and
an opening defined in a lower portion of the flange,
wherein the flange is provided to integrally extend from an upper edge of the opening in a direction to support the external electrode, and
the external electrode is seated on the flange and bonded to the flange by an electrically conductive bonding agent.

12. The metal frame for supporting electrical elements of claim 11, wherein the opening is defined to communicate with vertical and horizontal portions of the metal frame.

13. The metal frame for supporting electrical elements of claim 11, wherein the other opening is defined at the top of the flange through which an end surface of the external electrode of the electric element is exposed.

14. The metal frame for supporting electrical elements of claim 13, wherein the other opening is closed at all edges or opened at an upper edge.
